(19) United States
(12) Patent Application Publication
(10) Pub. No.: US 2013/0250738 A1
(43) Pub. Date: Sep. 26, 2013

(54) CLOCK

(71) Applicants: Sang-Min Kim, Yongin-si (KR); Jee-Yeon Lee, Jeonju-si (KR); Ji-Su Park, Jeonju-si (KR)

(72) Inventors: Sang-Min Kim, Yongin-si (KR); Jee-Yeon Lee, Jeonju-si (KR); Ji-Su Park, Jeonju-si (KR)

(21) Appl. No.: 13/601,955

(22) Filed: Aug. 31, 2012

(30) Foreign Application Priority Data
Mar. 23, 2012 (KR) 20-2012-0002358

(51) Int. Cl. G04B 19/24

(52) U.S. Cl. 368/29

(57) ABSTRACT

A clock includes a display including a plurality of planar portions and a plurality of bending portions disposed between the plane portions. The display is configured to display at least one of time, day, or day of the week. The clock also includes a bottom support for supporting one end of the display.

### CROSS-REFERENCE TO RELATED APPLICATION

This application claims priority to and the benefit of Korean Utility Model Application No. 20-2012-0002358 filed in the Korean Intellectual Property Office on Mar. 23, 2012, the entire content of which is incorporated herein by reference.

### BACKGROUND

(a) Field

Exemplary embodiments of the present invention relate to a clock.

(b) Description of the Related Art

A clock is a device for displaying or representing time, and may have various shapes and/or purposes. For example, a clock may be a small portable clock that is capable of confirming the time when a person is travelling, a desktop clock or a wall mounted clock that is installed at a predetermined place to be seen by many people, or an industrial clock used to determine a work process in various factories. Clocks are classified into an analog display type or a digital display type according to the method of displaying the time.

An analog clock displays time by a motion of clock hands that continuously or intermittently move.

A digital clock displays the passage of time as a number (or numbers) corresponding to the time, which may include hours, minutes and seconds. For example, a digital clock may display the current time, and/or may be used as a stopwatch. Further, an additional function may be added such as, for example, a display of the month, day, and year.

Recently, digital clocks have been designed with various shapes and functions in addition to the simple display of time.

The above information disclosed in this Background section is only for enhancement of understanding of the background of the invention and therefore it may contain information that does not form the prior art that is already known in this country to a person of ordinary skill in the art.

### SUMMARY

An exemplary embodiment of the present invention provides a clock, which may also have various additional functions.

According to an exemplary embodiment of the present invention, a clock includes: a display including a plurality of planar portions and a plurality of bending portions disposed between the planar portions, the display being configured to display at least one of time, day, or day of week; and a bottom support supporting one of two opposite ends of the display.

The display may be alternately bent or unbent at the plurality of bending portions to be folded or unfolded.

The display may be turned off when it is folded, and the display may be turned on when it is unfolded.

The display may include a plurality of organic light emitting elements.

At least a portion of the display may be configured to generate light.

The display may include a transparent or semi-transparent region.

The bottom support may include a fastener that is adapted to be fastened to the other of the two opposite ends of the display when the display is in a folded state.

The bottom support may have an alarm function for automatically generating a sound if a predetermined time is reached.

The display may be unfolded when the predetermined time is reached while the display is in a folded state.

The sound generated in the bottom support may be stopped when the unfolded display is folded.

The bottom support may further include controls for controlling at least one of information displayed at the display or an alarm time.

The bottom support may include a battery for supplying power to at least one of the display or the bottom support.

The clock may further include a side support at both sides of the display between the two opposite ends and supporting the display.

The side support may transmit an electrical signal to the display.

The side support may provide an elastic force in a direction in which the display is unfolded.

The clock according to exemplary embodiments may have various additional functions, thereby providing a convenience to a user.

### BRIEF DESCRIPTION OF THE DRAWINGS

FIG. 1 is a perspective view of a clock according to an exemplary embodiment of the present invention.

FIG. 2 is a side view of an operation shape of the clock of FIG. 1.

FIG. 3 is a top plan view of the clock of FIG. 1.

FIG. 4 is a bottom view of the clock of FIG. 1.

### DETAILED DESCRIPTION

Hereinafter, the present invention will be described more fully with reference to the accompanying drawings, in which an exemplary embodiment is shown. As those skilled in the art would realize, the described embodiment may be modified in various ways, all without departing from the spirit or scope of the present invention.

It shall be noted that the drawings are schematic and do not depict exact dimensions. The relative proportions and ratios of elements in the drawings may be exaggerated or diminished in size for the sake of clarity and convenience in the drawings, and such arbitrary proportions are only illustrative and not limiting in any way. Like reference numerals are used for like structures, elements, or parts shown in two or more drawings to show similar characteristics. When one part is said to be “over” or “on” another part, the one part may be directly over the other part or may be accompanied by another part interposed therebetween.

A described embodiment may specifically show one exemplary embodiment of the present invention. For example, embodiments depicted in the drawings may be variously modified as those skilled in the art would appreciate. Further, the present invention is not limited to the particular illustrated embodiments, but may include forms that are modified from the illustrated embodiments.

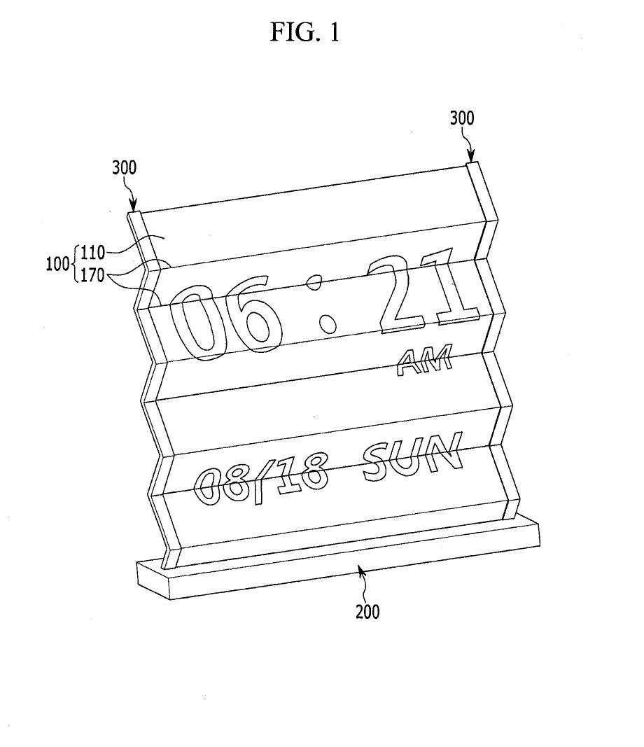

A clock according to an exemplary embodiment of the present invention will be described with reference to FIG. 1 to FIG. 4.

As shown in FIG. 1, a clock according to an exemplary embodiment of the present invention includes a display (e.g., display portion or display unit) 100 and a bottom support (e.g., bottom supporting portion) 200. Also, the clock may further include a side support (e.g., side supporting portion) 300.

The display 100 may display one or more of time, date, or day of the week.

Also, in an exemplary embodiment of the present invention, the display 100 includes a plurality of planar portions 110 and a plurality of bending portions 170 disposed between the planar portions 110. The plurality of bending portion 170 may be alternately bent or unbent (e.g., straightened) to fold or unfold the display 100. Here, when the display 100 is folded, the display 100 may be turned off such that the display of information such as time, date, or day of the week may be suspended. When the display 100 is unfolded, the display 100 may be turned on such that the information such as time, date, or day of the week may be displayed.

The display 100 may include one or more organic light emitting elements (e.g., organic light emitting diodes). That is, the display 100 may include a flexible organic light emitting diode (OLED) display that may be folded or unfolded. The flexible organic light emitting diode (OLED) display forming the display 100 may be one of various organic light emitting diode (OLED) displays. In the described embodiment, both the planar portions 110 and the bending portions 170 of the display 100 may include one or more light emitting elements of the flexible organic light emitting diode (OLED) display. This way, the bending portions 170 as well as the planar portions 110 may be used to display information or light.

Also, the display 100 may include a transparent or semi-transparent region.

For example, the region other than the region representing the time, date, day of the week, or any other information in the display 100 may be transparent or semi-transparent.

The display 100 may generate light as well as the display of at least one of time, day, or day of the week. When the display 100 includes a transparent or semi-transparent region, the light may be generated in the transparent or semi-transparent region.

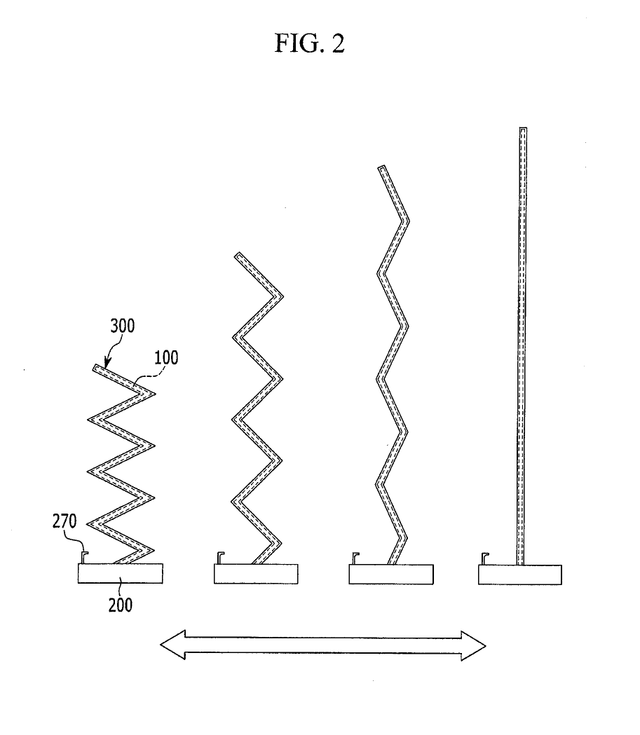

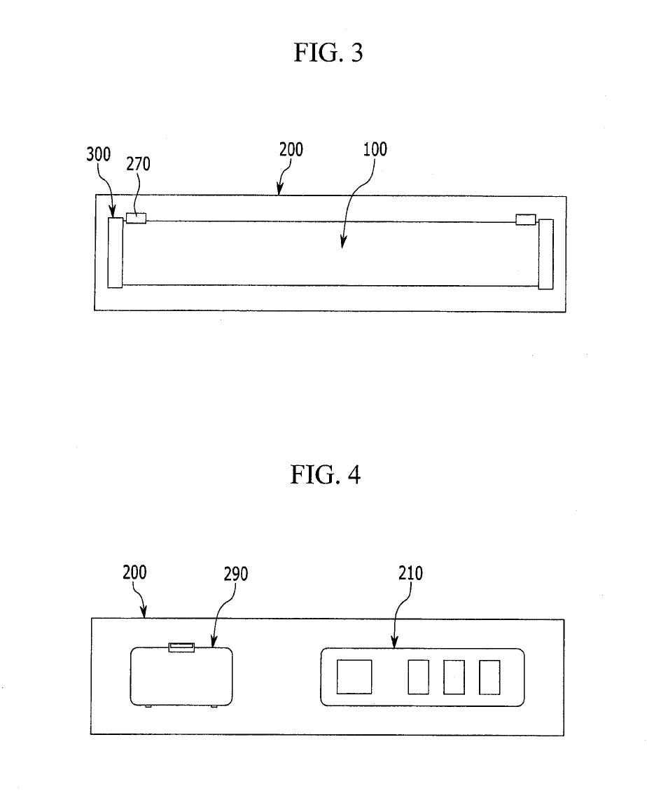

The bottom support 200 supports one end of the display 100. The folded display 100 may be adjacently located at (and supported by) the bottom support 200. Also, as shown in FIG. 2 and FIG. 3, the bottom support 200 includes a fastener (e.g., hook) 270 fastened (e.g., hooked) at the other end of the display 100 when the display 100 is folded. Accordingly, the display 100 may be fastened or hooked to the bottom support 200 in the folded state. In other words, the end of the display 100 that is opposite the end supported by the bottom support 200, may be held closely to (e.g., in proximity to or adjacent) the bottom support 200 by the fastener 270.

In FIG. 2 and FIG. 3, the fastener 270 has a hook shape, however the present invention is not limited thereto. The fastener 270 may use a magnet or various other structure and/or methods that are known to those skilled in the art.

Also, the bottom support 200 may have an alarm function for automatically generating a sound when a previously predetermined time is reached.

Also, in an exemplary embodiment of the present invention, the display 100 may be unfolded from the folded state when the previously predetermined time is reached. That is, the display 100 may be unfolded when the sound is generated at the bottom support 200. Further, when the unfolded display 100 is folded, the sound may be stopped.

As shown in FIG. 4, the bottom support 200 may further include controls (e.g., an adjusting portion) 210 for controlling information and/or the alarm time displayed on the display portion 100. The controls may also be used for turning the clock functionalities off/on. For example, the controls 210 may be located at the bottom surface of the bottom support 200.

The bottom support 200 may further include a battery 290 for supplying power to the display 100 and/or the bottom support 200.

In the above, as shown in FIG. 1 and FIG. 2, the side support 300 is respectively located at both edges of the display 100 to support the display 100. The side support 300 guides the operation in which the display 100 is folded or unfolded, and provides an elastic force in a direction in which the display 100 is unfolded. Accordingly, when the fastener 270 at the bottom support 200 is released while the display 100 is folded, the display 100 is slowly unfolded by the elastic force provided by the side support 300.

Also, the side support 300 electrically connects the bottom support 200 and the display 100, thereby transmitting electrical signals to the display 100.

An operating shape of the clock according to an exemplary embodiment of the present invention having this constitution will now be described in detail.

When a predetermined time is reached while the display 100 is in a folded state, the bottom support 200 may generate a sound. Also, the bottom support 200 releases the fastener 270 that is fastened to the other end of the display 100. The fastening by the fastener 270 may be released by the top portion of the display 100 moving away from the fastener 270 at the bottom support 200. Meanwhile, if the fastener 270 includes a magnet, the fastener may be released (e.g., the top portion of the display 100 is released by the fastener 270) by removing a magnetic force from the fastener 270. Thus, the folded display 100 is slowly unfolded by the elastic force of the side support 300. Additionally, the unfolded display 100 may be turned on, various information may be displayed and/or the light may be lit. The user may fold the unfolded display 100 to stop the sound corresponding to the alarm function. Finally, the folded display 100 may stop or suspend the information display or the generation of the illumination light.

By this constitution, a clock according to an exemplary embodiment of the present invention may have various additional functions, thereby providing convenience to the user. Also, the volume thereof is reduced during non-use while in the folded state, thereby providing greater portability.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims, and their equivalents.

Description of Some of Symbols

| | |
|---|---|
| 100: display | 110: planar portion |
| 170: bending portion | 200: bottom support |
| 210: controls | 270: fastener (e.g., hook) |
| 290: battery | 300: side support |

What is claimed is:

1. A clock comprising:
a display comprising a plurality of planar portions and a plurality of bending portions disposed between the planar portions, the display being configured to display at least one of time, date, or day of week; and
a bottom support supporting one of two opposite ends of the display.

2. The clock of claim 1, wherein
the display is alternately bent or unbent at the plurality of bending portions to be folded or unfolded.

3. The clock of claim 2, wherein
the display is turned off when it is folded, and the display is turned on when it is unfolded.

4. The clock of claim 2, wherein
the display comprises a plurality of organic light emitting elements.

5. The clock of claim 4, wherein
at least a portion of the display is configured to generate light.

6. The clock of claim 4, wherein the display comprises a transparent or semi-transparent region.

7. The clock of claim 2, wherein
the bottom support comprises a fastener that is adapted to be fastened to the other of the two opposite ends of the display when the display is in a folded state.

8. The clock of claim 2, wherein
the bottom support has an alarm function for automatically generating a sound if a predetermined time is reached.

9. The clock of claim 8, wherein
the display is unfolded when the predetermined time is reached while the display is in a folded state.

10. The clock of claim 9, wherein
the sound generated in the bottom support is stopped when the unfolded display is folded.

11. The clock of claim 8, wherein
the bottom support further comprises controls for controlling at least one of information displayed at the display or an alarm time.

12. The clock of claim 2, wherein
the bottom support comprises a battery configured to supply power to at least one of the display or the bottom support.

13. The clock of claim 2, further comprising
a side support located at both sides of the display between the two opposite ends and supporting the display.

14. The clock of claim 13, wherein
the side support is configured to transmit electrical signals to the display.

15. The clock of claim 13, wherein
the side support provides an elastic force in a direction in which the display is unfolded.
